(19) United States
(12) Patent Application Publication
(10) Pub. No.: US 2013/0061589 A1
(43) Pub. Date: Mar. 14, 2013

(54) HYDRAULIC POWER CONVERTER

(71) Applicants: Abraham Bauer, Herzliya (IL); Yony Weiss, Moshav Misgav Dov (IL)

(72) Inventors: Abraham Bauer, Herzliya (IL); Yony Weiss, Moshav Misgav Dov (IL)

(21) Appl. No.: 13/641,277

(22) PCT Filed: Apr. 27, 2011
(86) PCT No.: PCT/IB11/51831

§ 371 Date: Nov. 29, 2012

Related U.S. Application Data
(60) Provisional application No. 61/328,746, filed on Apr. 28, 2010.

(51) Int. Cl. F15B 13/00

(52) U.S. Cl. CPC F15B 13/00
USPC 60/416

(57) ABSTRACT

An energy storage system that converts irregular power to controlled power by a hydraulic power converter that utilizes the irregular power to pump hydraulic fluid, stores at least a part of the pumped hydraulic fluid in a pressurized accumulator cluster, and provides controlled power by a hydraulic motor operated by pressurized hydraulic fluid from the accumulator cluster, according to a specified power demand. The operation of the hydraulic power converter may be controlled electrically and mechanically, and the hydraulic power converter may be integrated in a vehicle, to maintain an optimal operation range of the engine, or in an energy production device, for generating controlled power from the irregular output of the device.

### CROSS REFERENCE TO RELATED APPLICATIONS

This application claims the benefit of U.S. Provisional Patent Application 61/328,746 filed on 28 Apr. 2010, which is incorporated herein by reference.

### BACKGROUND OF THE INVENTION

1. Technical Field

The present invention relates to a energy storage, power management and more particularly, to managing power by hydraulic means.

2. Discussion of the Related Art

The development of renewable energy sources on the one hand, and the efforts of managing the electricity supply on the other, raise a acute need to handle efficiently irregular power supply and variable demand for electricity. For example, solar plants supply energy only during sunny days, and wind turbines supply power only when it is windy. Electricity demand is characterized by a peak, that requires more power stations to be built to supply the peak demand, than necessary to supply the average demand. To summarize, a system is needed to regulate power supply over time.

Hybrid vehicles become more and more common as regulation on emissions become stringent and more incentives are provided for switch from conventional cars into more environmentally friendly vehicles. There are 2 kind of hybrid power-train:

(i) Parallel propulsion, where internal combustion engine (ICE) and another engine type are being combined thru parallel gear mechanism to provide power to the wheels. Each energy source may be activated by itself.

(ii) Serial propulsion, where one ICE engine is connected through storage device i.e. accumulator 110 (FIGS. 1A and 1B) which is powering the wheels through a second type engine. The second power-train type can work without an accumulator as well. Accumulator 110 comprises nitrogen gas which is compressed by pressurized oil, and may expand to supply the pressurized oil. Typical accumulator volumes range 10-100 liters and typical pressures 100-500 bar.

In the two architectures the ICE is activated in the same mode as standard ICE, with the other power source cut in and out to support reduction in fuel consumption.

### BRIEF SUMMARY OF THE INVENTION

One aspect of the invention provides a hydraulic power converter receiving irregular power from a source and delivering controlled power to a load, the hydraulic power converter comprising: (i) a hydraulic pump arranged to receive the irregular power from the source and use the irregular power to pump a hydraulic fluid from a hydraulic fluid reservoir in high efficiency, (ii) a hydraulic motor arranged to deliver power to the load, (iii) at least three accumulators, each arranged to receive, store and supply hydraulic pressure, and (iv) a control unit comprising: a manifold in fluid communication with the accumulators, with the hydraulic fluid reservoir, and with the hydraulic pump and the hydraulic motor, the manifold arranged to receive the pumped hydraulic fluid from the hydraulic pump, to deliver the pumped hydraulic fluid to the accumulators and to receive pressurized hydraulic fluid from the accumulators according to specified rules, and to deliver, via the hydraulic motor, controlled power to the load according to a specified power demand, and a control module arranged to control the manifold according to the specified rules and the specified power demand.

This, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 2A, 2B and 3 are high level schemes illustrating a hydraulic power converter, according to some embodiments of the invention;

FIGS. 4A and 4B are high level schemes illustrating the hydraulic power converter in a vehicular application, according to some embodiments of the invention;

FIG. 5 is a high level flowchart illustrating an operation scheme of the hydraulic power converter in a vehicular application, according to some embodiments of the invention;

FIGS. 6A and 6B are high level illustrations of the operation of the hydraulic power converter in a vehicular application, according to some embodiments of the invention;

FIGS. 7 and 8 are high level schemes illustrating the hydraulic power converter in association with a wind turbine, according to some embodiments of the invention; and

FIG. 9 is a high level flowchart illustrating a method of converting irregular power to controlled power, according to some embodiments of the invention.

The drawings together with the following detailed description make apparent to those skilled in the art how the invention may be embodied in practice.

### DETAILED DESCRIPTION OF THE PRESENT INVENTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

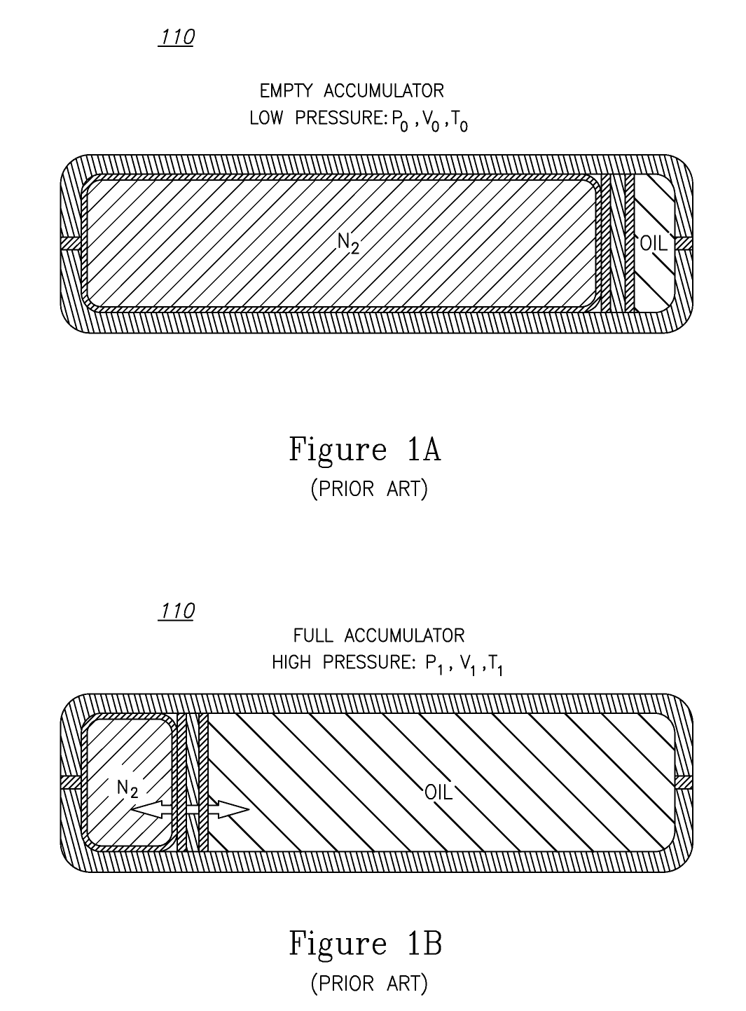

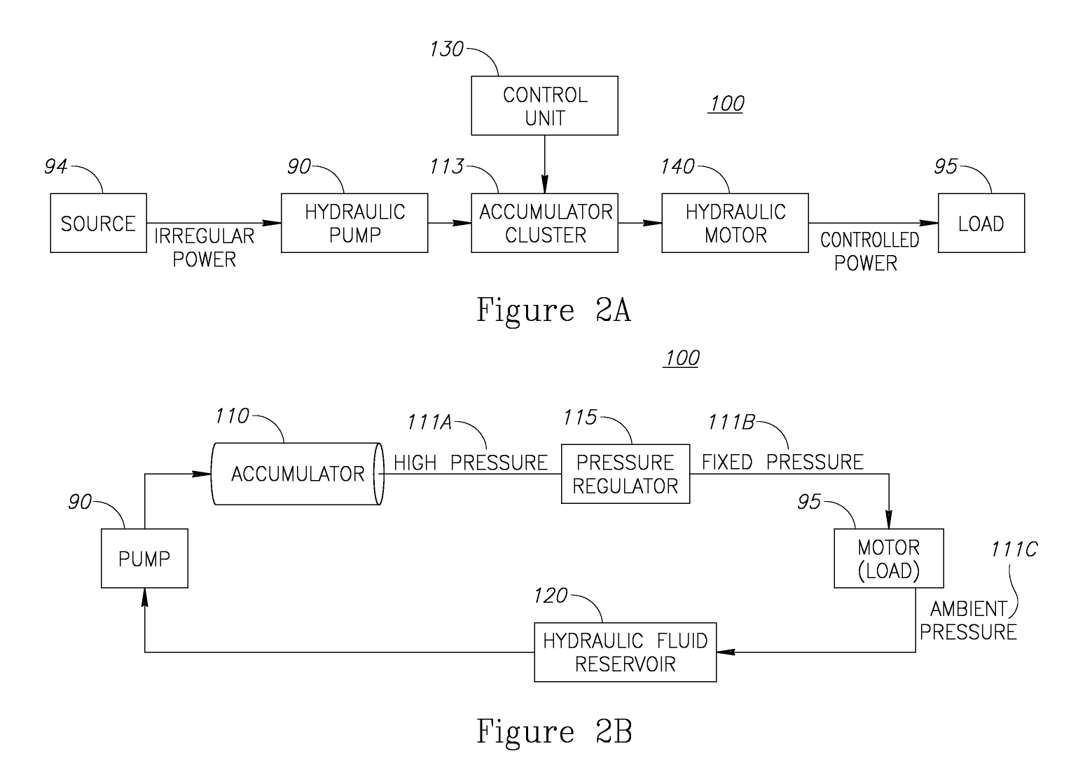

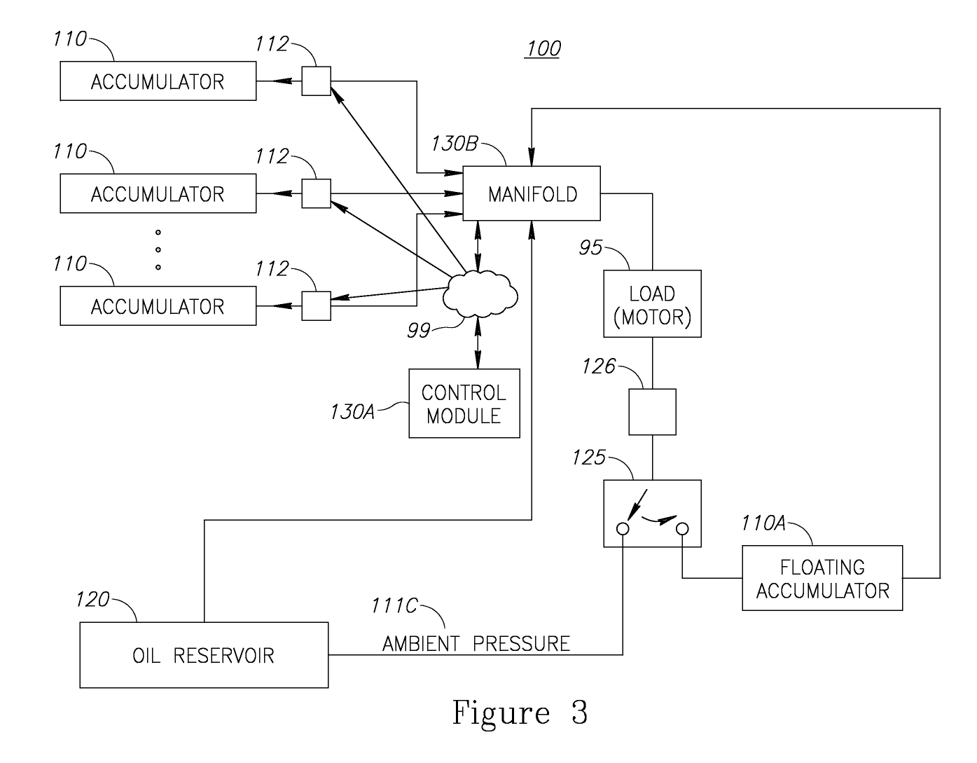

FIGS. 2A, 2B and 3 are high level schemes illustrating a hydraulic power converter 100, according to some embodiments of the invention.

Hydraulic power converter 100 receives irregular or discontinuous power supply from a source 94 and delivers controlled power to a load 95. Hydraulic power converter 100 comprises a hydraulic pump 90 arranged to receive the irregular power from source 94 and use the irregular power to pump a hydraulic fluid from a hydraulic fluid reservoir 120 to at least three accumulators 110 arranged in an accumulator cluster 113, each accumulator 110 arranged to receive, store and supply hydraulic pressure.

Hydraulic power converter 100 further comprises a control unit 130 comprising a manifold 130B in fluid communication with accumulators 110, with hydraulic fluid reservoir 120, and with hydraulic pump 90 and a hydraulic motor 140 that delivers the controlled power to load 95.

Manifold 130 is arranged to receive the pumped hydraulic fluid from hydraulic pump 90, to deliver the pumped hydraulic fluid to accumulators 110 and to receive pressurized hydraulic fluid from accumulators 110 according to specified rules, and to deliver, via hydraulic motor 140, controlled power to load 95 according to a specified power demand. Control unit 130 further comprises a control module 130A arranged to control manifold 130B according to the specified rules and the specified power demand.

At least one of accumulators 110 may be a floating accumulator 110A (FIG. 3), connected serially to hydraulic motor 140 and arranged to reduce a pressure provided by manifold 130B to a specified pressure level by storing a part of the provided pressurized hydraulic fluid. Using floating accumulator 110A allows adjusting the provided pressure level to the required power by the load, and so avoid heat losses and waste of hydraulic pressure. Additionally, determining the hydraulic pressure on hydraulic motor 140 allows controlling the provided power. Floating accumulator 110A may also comprise an accumulator cluster that is arranged to temporarily store an expected amount of pressurized hydraulic fluid. After storing the pressurized hydraulic fluid, floating accumulator 110A may provide the stored power to hydraulic motor 140 or to accumulators 110, as determined by control unit 130.

The hydraulic storage of the irregular power and the supply of the controlled power to load 95 may be temporally separated. For example, power storage may take place at night and power supply at daytime.

For example, hydraulic power converter 100 may be used in isolated off grid areas for electricity management and supply. A system comprising a solar and/or a small wind turbine as source 94 that is connected directly to hydraulic pump 90, that charges accumulator cluster 113. The system can be scaled to accommodate various supply scenarios including but not limited to long term supply without sun or wind.

In another example, hydraulic power converter 100 may be used for grid scale electrical system supply stabilization and storage. When remote areas suffer from irregular power deliveries including voltage and frequency disorder, hydraulic power converter 100 may be designed to overcome these issues.

Control module 130A may be connected to manifold 130B via a communication link 99, such as wire or wireless communication.

Hydraulic power converter 100 may be arranged to maintain variable pressure levels in accumulators 110 by comprising controlled valves 112 that are arranged to control and regulate the pressure level in each respective accumulator 110. The separate control over each accumulator 110 allows reaching a high pressure level with a relatively low amount of hydraulic fluid. Valves 112 may be controlled by control module 130A over communication link 99.

The electric system delivers power to electrical hydraulic pump system 90 that charges distributed accumulator system 113. Accumulator system 113 in its turn delivers the power to the grid by hydraulic motor 140 that is coupled to a generator as load 95. The system allows to deliver fixed voltage and frequency for any input distribution. Hydraulic power converter 100 thus acts as buffer between the two parts of the grid.

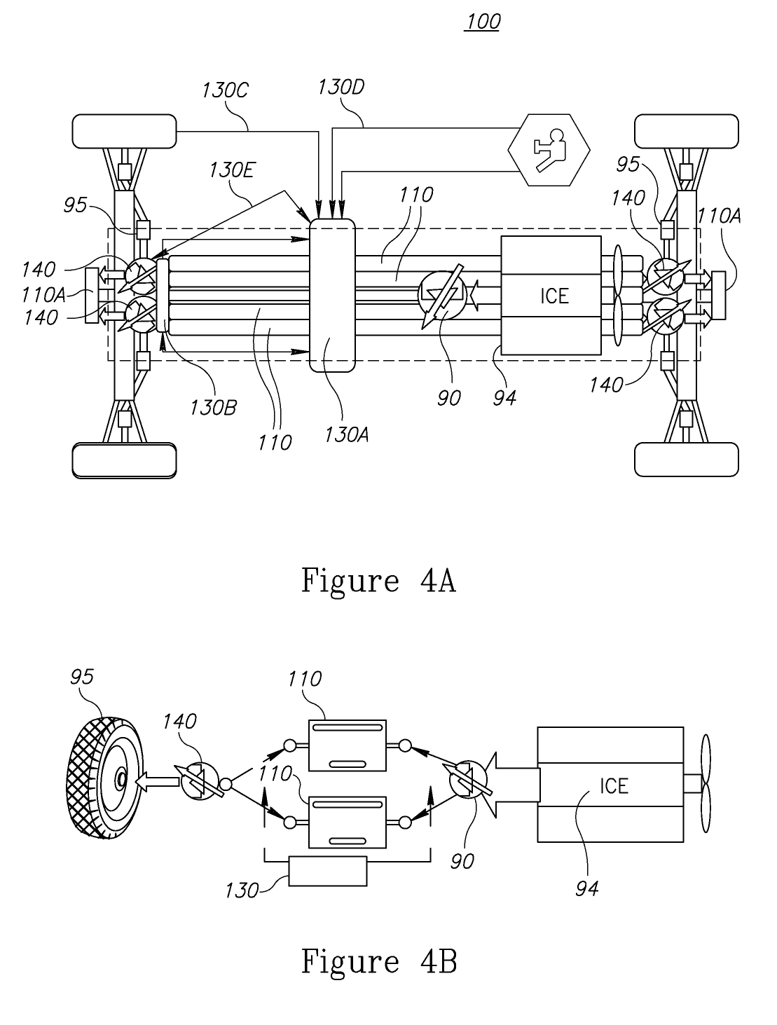

Hydraulic power converter 100 may be integrated in a vehicle and use source 94 as the vehicle's engine (e.g. see internal combustion engine—ICE below) and a deceleration power generator, that generates power by braking the wheels. Load 95 may be the propulsion means, such as vehicle wheels or possibly the drive shaft or the vehicle's gear. In this case, accumulators 110 may be integrated in the vehicle's chassis (as explained below) and control unit 130 may be arranged to maintain the vehicle engine within a specified power output range, by removing excessive power into the accumulators and providing missing power from accumulators 110 (see below). Hydraulic motor 140 may comprise four hydraulic motors 140 (FIG. 4A), each associated with a wheel of the vehicle to provide the vehicle with an all wheels power control.

The deceleration power generator may be arranged to regenerate breaking power by reversing a hydraulic fluid flow direction through hydraulic power converter 100 to load at least one of accumulators 110 upon vehicle deceleration.

Accumulators may be of any current or future type, for example the nitrogen gas accumulators illustrated in FIGS. 1A, 1B. The hydraulic fluid may be oil. The following illustrates a calculation of storable energy in accumulator 110.

Accumulator 110 is constructed of five parts: container, nitrogen bladder, piston and two valves. In order to maximize the energy stored by the nitrogen it is pre-pressurized to the working pressure of hydraulic motor 140, this way all the oil contained in accumulator 110 can run hydraulic motor 140. All energy storage is contained in the gas when the oil, as uncompressible media, is pressing the nitrogen bladder to its maximum pressure. Accumulator 110 may be any pressure storage reservoir, of any kind, such as a bladder or a piston.

Since Nitrogen at above 33 bar cannot be treated as ideal gas one must use the nitrogen thermodynamic properties at each state in accumulator 110 (according to Table 1).

TABLE 1
Nitrogen gas thermodynamic properties
(from the Nitrogen Database).

| | | |
|---|---|---|
| Pressure, [bar] | 100 | 500 |
| Temperature, [deg C.] | 27 | 41 |
| phase: Supercritical Liquid, SL | SL | SL |
| Density, [kg/m\hat{ }3] | 111.7 | 395.2 |
| Specific heat Cp, [KJ/(kg K)] | 0.03347 | 0.03786 |
| Specific heat Cv, [KJ/(kg K)] | 0.02179 | 0.02362 |
| Entropy J/(mol K) | 151.8 | 136.7 |
| Entropy KJ/(Kg K), s | 5.42 | 4.88 |
| Enthalpy, [kJ/mol] | 8.183 | 8.185 |
| Enthalpy, [kJ/Kg], h | 292.11 | 292.18 |
| internal energy, [kJ/mol] | 202.6 | 165.7 |
| internal energy, [kJ/Kg], u | 7,232.25 | 5,915.03 |

For the calculation example pre-pressurized state is taken as 100 bar and the pressure in the full accumulator is taken as 500 bar: Initial state (i)—all the accumulator is filled with gas at 100 bar and 27° C. (FIG. 1A). Final state (f)—accumulator contains oil and compressed gas, with the same weight, at 500 bar and 41° C. (FIG. 1B).

Knowing the gas initial conditions defines the gas mass that is not changing the all process. From the first law of thermodynamics one can calculate the work done by the oil on the gas.

ΔU=Q+W

Where ΔU is the change in internal energy, Q is the heat exchange with the gas and W is the work done by the oil on the gas.

Designing the accumulator in a way that minimal heat is exchanged between the gas and it boarders will define the stored energy, that is equal to work W, as the change in internal energy where Q=ΔH equals zero (0). Knowing the final state, gas is compressed to the highest pressure, we can define the volume the gas captures and from that calculating the amount of oil contained in the accumulator.

FIGS. 4A and 4B are high level schemes illustrating hydraulic power converter 100 in a vehicular application, according to some embodiments of the invention.

An ICE (internal combustion engine as source) 94 is connected to an energy conversion unit which may be electric generator in electric hybrid propulsion or pump 90 in hydraulic propulsion or any other energy conversion unit. The energy conversion unit may be connected into one of at least four storage devices 110. Storage devices 110 are connected to hydraulic motors 140 which convert the energy into rotation. Energy conversion unit 90 reflects to ICE 95 an optimal load. Motors 140 are turning the wheels.

In embodiments, the system may comprise one ICE 95, hydraulic pump 90, cluster 113 of accumulators 110 with at least three energy storage devices, two or four hydraulic motors 140 that power the wheels as load 94, low pressure container 120 and control system 130 as described in following schematic description.

ICE 95 is activated at its most efficient working point in a constant speed (RPM). In order to provide optimal energy generation, storage device 110 is connected to ICE 95 through hydraulic pump 90. Hydraulic ump 90's role is to load accumulator 110 while reflecting to ICE 95 optimal load in terms of efficiency. Control system 130 is measuring the pressure and a fluid flow between accumulator 110 and pump 90 and adjusts the flow rate to reflect optimal load to ICE 95. ICE 95 works in a duty cycle meaning running at its optimal point as described when charging accumulators 110 or shutting down when not needed according to commands from control system 130.

In prior art optimal ICE 95 may reach efficiency of over 40%, in compare to common architecture where ICE 95 has to cope with variable conditions and may get to 30% in average. This is still better than conventional power-train systems but inferior to this invention.

The power-train has cluster 113 of accumulators 110 with at least four accumulators 110. Accumulators 110 may be identical in properties and each may perform any task required in the system such as energy storage, energy discharge to motors 140 and energy regeneration from the wheels while decelerating (as source 94). Accumulator cluster 113 may be designed to serve as the vehicle's chassis to reduce vehicle's weight.

FIG. 4A further illustrates different types of input to control system 130, such as acceleration and deceleration commands 130D from the driver, speed data 130C from the wheels or vehicle computer, and commands 130E from sensors in hydraulic power converter 100 itself, e.g. associated with hydraulic pump 90, hydraulic motor 140, manifold 130B and accumulators 110.

The vehicular implementation of hydraulic power converter 100 is not limited to wheeled vehicles, and may include propelled boats or other engine motivated vehicles.

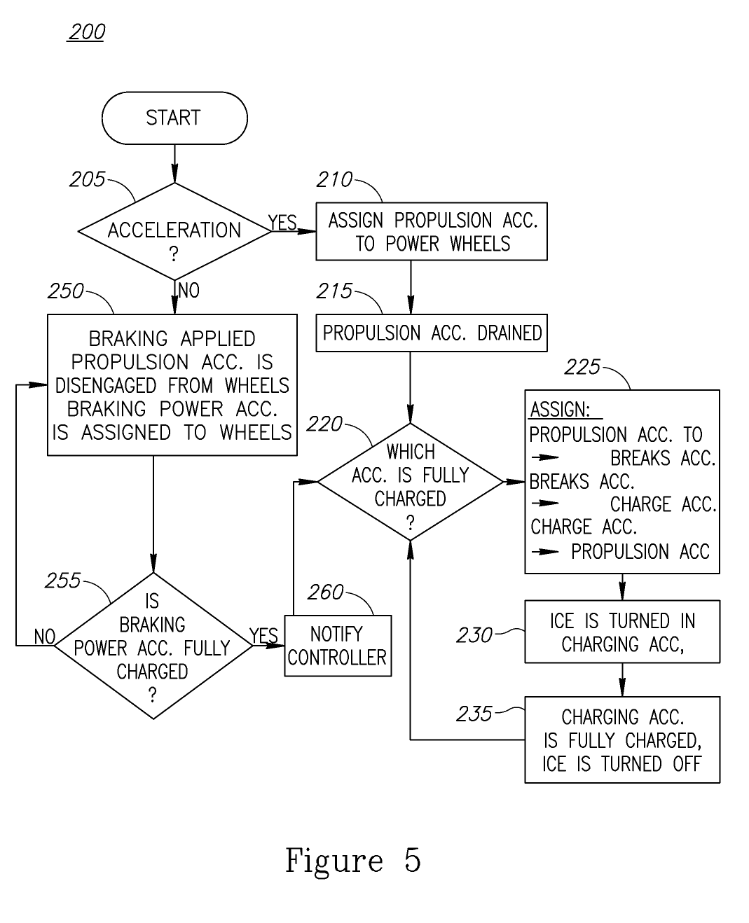

FIG. 5 is a high level flowchart illustrating an operation scheme of hydraulic power converter 100 in a vehicular application, according to some embodiments of the invention.

The control system is dynamically assigning accumulators 110 per task, based on current situation and functionality, for example, if an accumulator 110 has just been discharged to the wheels (210, 215), it may be assigned to become available for decelerating energy regeneration (225, 250), or may directed to pump 90 if there is already empty accumulator 110. Another benefit of the system configuration is that unlike prior art systems, the system doesn't have to assign in advance high pressure and low pressure accumulators, limiting thereby the use of stored energy to specific functionality hence creating in efficient energy scheme. In the current invention, accumulator 110 which is partially charged by the breaking energy may be assigned to be fully charged by pump 90 hence making room for zero charged accumulators 110 to be assigned to regenerative breaking and immediate use of regenerated energy in powering the vehicle. The current invention of accumulators cluster 113 allows on top of the energy flexibility better vehicle weight distribution and redundancy in the vehicle operation, in case one accumulator 110 is malfunctioning.

Another benefit of the control system may be applied in conjunction with features like location based services, for example in case of hilly areas, when the vehicle is aware of a long uphill coming, all accumulators 110 may be charged in advance to allow more available power going uphill. When a vehicle is identifying a long downhill drive, ICE 95 may not charge accumulators 110 and allow as much storage capacity available for decelerating power regeneration.

Hydraulic power converter 100 may also be used to maximize energy value in respect to a given feeding tariff, for example by storing the produced energy in accumulators 110 until a time with a high feeding tariff.

For example, an operator of a wind tower storage unit that is loaded to a certain extent may, by means of weather forecast, determine whether or not to discharge energy to the grid in low payment return time knowing that soon after the system will be loaded by strong wind surge, hence maximizing income from a unit.

Main Benefits of the system include: 1. Using open loop hydraulic system with various pressure levels in each accumulator (prior art uses closed loop). 2. This benefit is particular to the vehicular application internal combustion engine used in optimal load and frequency, in prior art, when using fixed frequency still changes the load to the engine, hence the air to fuel ratio changes and emissions rise although the engine runs at fixed frequency and/or optimized energy efficiency point. 3. Distributed accumulator system—enables better control and use of energy and isolation of fractured elements, and also enables to reach high pressure levels with liquid volume pumped 4. Chassis—accumulator integration (in the vehicular application)—lowers the weight of the vehicle. 5. Location based energy management (with GPS for example), the accumulators are managed with location awareness (feeding of uphill downhill to the system management). 6. Implementation of electronic stability system and control of wheel motor.

The invention implements an accumulator cluster 113 having distributed accumulation elements 110 based on small wide range accumulators 110. Accumulators 110, due to high pressure they have to stand, require rigid and solid structure. Each accumulator 110 may be arranged to handle a specified pressure level, which may differ among accumulators 110 according to design specification of cluster 113, such as to allow operation of cluster 113 at internally varying pressure levels. Commercial accumulators have a tube shape pattern and due to mechanical requirements they have a thick and heavy metal pack. The weight of a 50 liters accumulator may exceed the 100 Kg, use of two accumulators (high pressure and low pressure) may result in significant mass addition which results in extra cost and extra fuel consumption. The mechanical properties of accumulator 110 allow using it as structural element. Hence instead of having accumulators 110 on top of the chassis, the two functions are integrated into a single element—an accumulator chassis. This element provides mass and cost reduction, lower fuel consumption and higher strength.

The use of accumulators as storage devices enables options like start/stop and low emissions driving especially in urban traffic. The activation of ICE in the most optimum energy efficiency point and the periodic deactivation of the ICE enable a fuel consumption reduction to its half.

The distributed motor architecture eliminates the need for differential unit but at the same time it has creates a challenging situation where right hand side wheel and left hand side wheel rotate at a speed which is not identical as it is activated in open loop mode. In order to balance the car there is a need to match the speed between the sides. Prior art is discussing methods of balancing the torque on each wheel, however this approach assumes that with balanced torque all the other factors like wheel-motor transfer functions, wheel diameter and angular speed are equal between the wheels. The current invention describes a method of balancing the wheels by matching speeds of the wheels, the speed is sensed with speed sensors and a control loop is balancing the flow of oil into the wheel-motor to match between the sides. This method actually takes care of balancing the car in extreme conditions as well, hence providing stability control with zero cost adders.

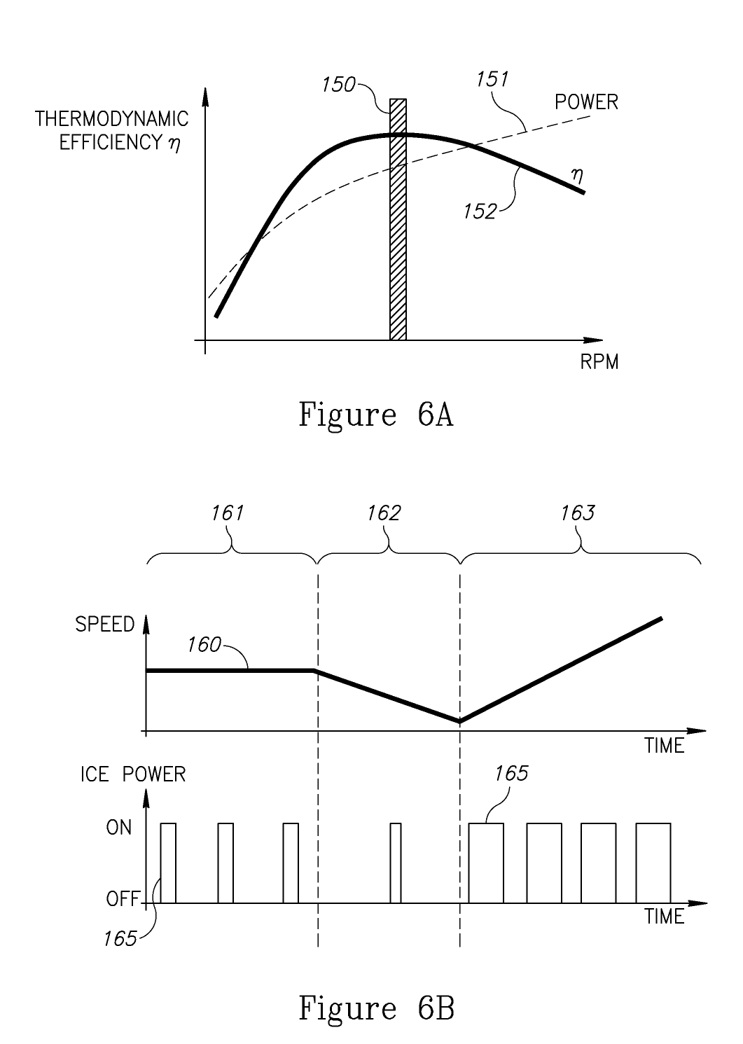

FIGS. 6A and 6B are high level illustrations of the operation of the hydraulic power converter in a vehicular application, according to some embodiments of the invention;

FIG. 6A illustrates the two characteristic curves of a typical ICE 95. Power curve 151 is monotonically rising while efficiency curve 152 has a maximum efficiency point in the midpoint. Hydraulic power converter 100 keeps engine 95 in its optimal working point 150, in time cycles controlled by demand, hence making sure that the engine is in its most efficient functionality.

FIG. 6B illustrates speed 160 and ICE power in time while driving in constant speed 161, deceleration 162, acceleration 163 and the corresponding activation 165 of ICE 95. ICE is activated at optimal performance 150, and is switched on and off by the system. Both ICE activation period and duty cycle are controlled by control system 130.

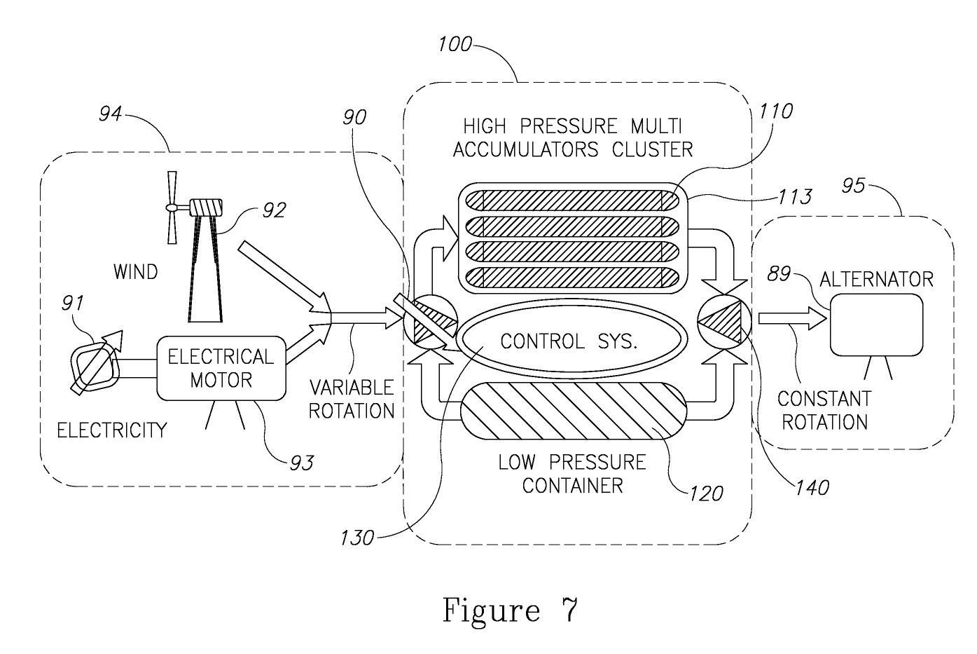

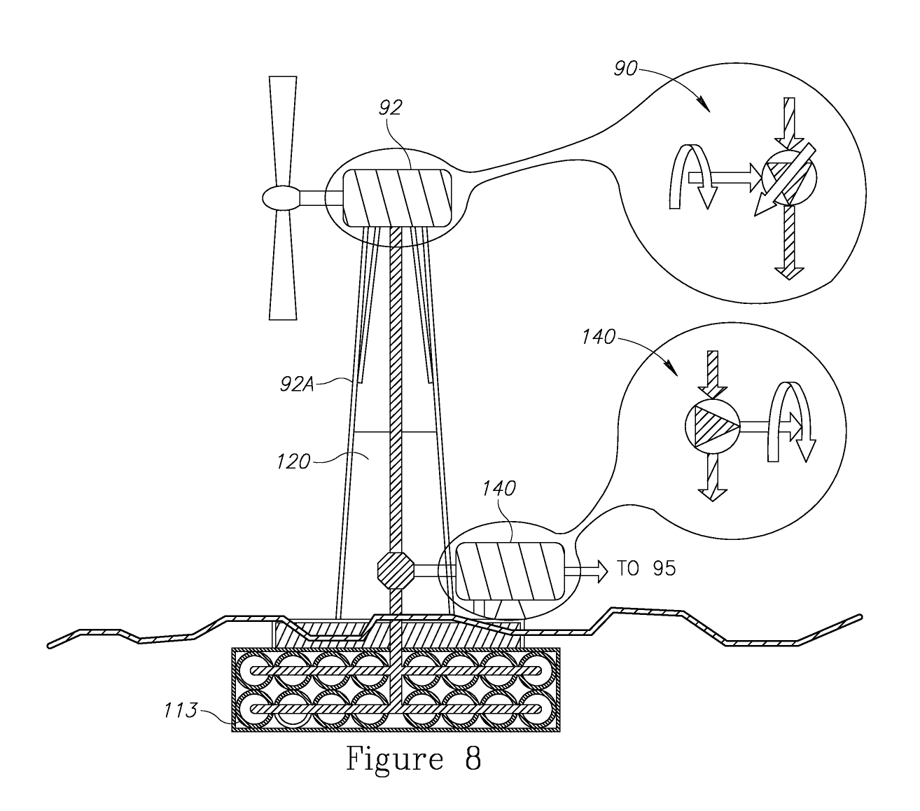

FIGS. 7 and 8 are high level schemes illustrating the hydraulic power converter in association with a wind turbine, according to some embodiments of the invention.

Hydraulic power converter 100 may be integrated in various energy provision systems, such as wind turbines 92, solar panels, steam turbines, etc., or even in the electric grid 91 itself (e.g. through an electric outlet) to turn often irregularly produced power into regular and controlled electricity. In case of electric source 91, an electric motor 93 may be used to operate hydraulic pump 90.

For example, hydraulic motor 140 may be connected to an alternator 89 as load 95, which feeds electricity into the grid or produces electricity for local needs.

In case of wind turbine 92, hydraulic fluid reservoir 120 may be located within a support 92A of wind turbine 92 and accumulator cluster 113 may be positioned under support 92A, e.g. underground.

In addition to the automotive application where hydraulic storage is used for low cost energy storage there are few more field areas where hydraulic storage could be useful.

The scalable storage system enables various energy storage applications that allow not only low cost storage but also on demand energy release. An application may include wind turbine or solar collector in isolated houses on one hand or isolated remote relay stations and monitoring stations which cannot rely on solar or wind power supply by itself.

Commercial wind power storage system may consist of hydraulic pump 90 connected to the rotor that may turn the pump's shaft, compress oil through one of accumulators 110. Accumulator 110, once fully charged, may be disconnected from pump 90, letting room for the next accumulator 110. When all accumulators 110 are charged, the bypass switch may run the electricity to the consumer (whether it's grid or isolated user). When energy is demanded hydraulic motor 140 may be activated and turn the generator to provide electricity to the user.

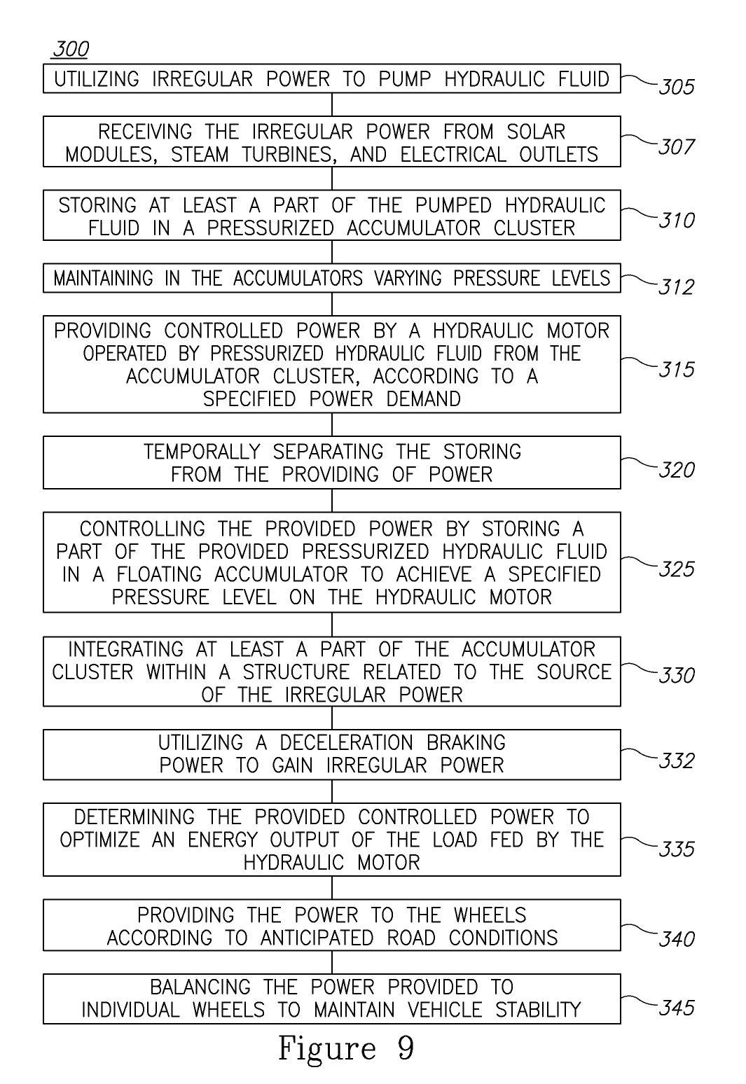

FIG. 9 is a high level flowchart illustrating a method 300 of converting irregular power to controlled power, according to some embodiments of the invention.

Method 300 comprises at least some of the following stages: utilizing an irregular power to pump hydraulic fluid (stage 305), storing at least a part of the pumped hydraulic fluid in a pressurized accumulator cluster (stage 310), providing controlled power by a hydraulic motor operated by pressurized hydraulic fluid from the accumulator cluster, according to a specified power demand (stage 315), and possibly also: temporally separating the storing from the providing of power (stage 320), controlling the provided power by storing a part of the provided pressurized hydraulic fluid in a floating accumulator to achieve a specified pressure level on the hydraulic motor (stage 325), integrating at least a part of the accumulator cluster within a structure related to a source of the irregular power (stage 330), and determining the provided controlled power to optimize an energy output of a load fed by the hydraulic motor (stage 335).

Method 300 may be implemented in a wheeled vehicle by receiving the irregular power from the engine and providing the controlled power to the wheels. In this case method 300 may further comprise providing the power to the wheels according to anticipated road conditions (stage 340) and balancing the power provided to individual wheels to maintain vehicle stability (stage 345). Method 300, implemented in a wheeled vehicle, may further comprise utilizing a deceleration braking power as at least a part of the irregular power (stage 332).

Method 300 may further comprise receiving the irregular power from at least one of: at least one solar module, at least one steam turbine, and an electrical outlet (stage 307).

Method 300 may further comprise maintaining in the accumulators varying pressure levels (stage 312).

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

While the invention has been described with respect to a limited number of embodiments, these should not be construed as limitations on the scope of the invention, but rather as exemplifications of some of the preferred embodiments. Other possible variations, modifications, and applications are also within the scope of the invention.

What is claimed is:

1. A hydraulic power converter receiving irregular power supply from a source and delivering controlled power to a load, the hydraulic power converter comprising:
a hydraulic pump arranged to receive the irregular power from the source and use the irregular power to pump a hydraulic fluid from a hydraulic fluid reservoir,
at least one hydraulic motor arranged to deliver power to the load,
a cluster of at least three accumulators, each arranged to receive, store and supply hydraulic pressure, and
a control unit comprising:
a manifold in fluid communication with the accumulators, with the hydraulic fluid reservoir, and with the hydraulic pump and the hydraulic motor, the manifold arranged to receive the pumped hydraulic fluid from the hydraulic pump, to deliver the pumped hydraulic fluid to the accumulators and to receive pressurized hydraulic fluid from the accumulators according to specified rules, and to deliver, via the at least one hydraulic motor, controlled power to the load according to a specified power demand, and
a control module arranged to control the manifold according to the specified rules and the specified power demand.

2. The hydraulic power converter of claim 1, wherein at least one of the accumulators is a floating accumulator, connected serially to the at least one hydraulic motor and arranged to reduce a pressure provided by the manifold to a specified pressure level by storing a part of the provided pressurized hydraulic fluid.

3. The hydraulic power converter of claim 1, wherein the accumulators are nitrogen gas accumulators.

4. The hydraulic power converter of claim 1, wherein a hydraulic storage of the irregular power and the supply of the controlled power to the load are temporally separated.

5. The hydraulic power converter of claim 1, wherein the source is at least one of: an vehicle engine and a deceleration power generator, and wherein the load is at least one of: wheels, drive shaft and gear of the vehicle.

6. The hydraulic power converter of claim 5, wherein at least some of the accumulators are integrated in the vehicle chassis.

7. The hydraulic power converter of claim 5, wherein the control unit is arranged to maintain the vehicle engine within a specified power output range, by removing excessive power into the accumulators and providing missing power from the accumulators.

8. The hydraulic power converter of claim 5, wherein the deceleration power generator is arranged to regenerate breaking power by reversing a hydraulic fluid flow direction through the hydraulic power converter to load at least one of the accumulators upon vehicle deceleration.

9. The hydraulic power converter of claim 5, wherein the at least one hydraulic motor comprises four hydraulic motors, each associated with a wheel of the vehicle to provide the vehicle with an all wheels power control.

10. The hydraulic power converter of claim 1, wherein the load is at least one alternator arranged to generate electricity from the delivered power.

11. The hydraulic power converter of claim 1, wherein the source is a wind turbine.

12. The hydraulic power converter of claim 11, wherein the hydraulic fluid reservoir is located within a support of the wind turbine and the accumulators are positioned under the support.

13. The hydraulic power converter of claim 1, wherein the source comprises at least one solar module.

14. The hydraulic power converter of claim 1, wherein the source comprises at least one steam turbine.

15. The hydraulic power converter of claim 1, wherein the source comprises an electrical outlet.

16. The hydraulic power converter of claim 1, wherein the hydraulic fluid is oil.

17. The hydraulic power converter of claim 1, wherein the control module is arranged to control the manifold over a communication link.

18. The hydraulic power converter of claim 1, further comprising a plurality of controlled valves, controllable by the control module and each associated with one of the accumulators, each valve arranged to maintain a specified pressure level in the associated accumulator.

19. A method of converting irregular power to controlled power, comprising:
utilizing the irregular power to pump hydraulic fluid,
storing at least a part of the pumped hydraulic fluid in a pressurized accumulator cluster,
providing controlled power by at least one hydraulic motor operated by pressurized hydraulic fluid from the accumulator cluster, according to a specified power demand.

20. The method of claim 19, further comprising temporally separating the storing from the providing of power.

21. The method of claim 19, further comprising controlling the provided power by storing a part of the provided pressurized hydraulic fluid in a floating accumulator to achieve a specified pressure level on the at least one hydraulic motor.

22. The method of claim 19, further comprising integrating at least a part of the accumulator cluster within a structure related to a source of the irregular power.

23. The method of claim 19, further comprising determining the provided controlled power to optimize an energy output of a load fed by the at least one hydraulic motor.

24. The method of claim 19, implemented in a wheeled vehicle by receiving the irregular power from the engine and providing the controlled power to the wheels, and further comprising providing the power to the wheels according to anticipated road conditions and balancing the power provided to individual wheels to maintain vehicle stability.

25. The method of claim 19, implemented in a wheeled vehicle by receiving the irregular power from the engine and providing the controlled power to the wheels, and further comprising utilizing a deceleration braking power as at least a part of the irregular power.

26. The method of claim 19, further comprising receiving the irregular power from at least one of: at least one solar module, at least one steam turbine, and an electrical outlet.

27. The method of claim 19, further comprising maintaining varying pressure levels in accumulators of the cluster.
